(19) United States
(12) Patent Application Publication
(10) Pub. No.: US 2023/0169532 A1
(43) Pub. Date: Jun. 1, 2023

(54) TARGETED GAMIFIED ECOMMERCE SERVICE

(71) Applicant: NCR Corporation, Atlanta, GA (US)

(72) Inventors: Max Groves, Atlanta, GA (US); Nathalie Chikhi, Apopka, FL (US); Jin Cheng Gao, Marietta, GA (US); Noah Tyler Gardner, Dacula, GA (US); Yassine Attia, Atlanta, GA (US)

(21) Appl. No.: 17/536,833

(22) Filed: Nov. 29, 2021

(51) Int. Cl. G06Q 30/02; G06Q 20/36

(52) U.S. Cl. CPC G06Q 30/0209; G06Q 20/36; G06Q 30/0222; G06Q 30/0239

(57) ABSTRACT

A targeted gamified ecommerce service is provided. The service interacts with a mobile application (app) of a consumer operated device and transaction systems and loyalty system of retailers. The consumer interacts with the app to search for a desired good/service, which the consumer is interested in purchasing. The service locates retailers providing the good/service and obtains pricing and offers from the retailers through interaction with the transaction system and loyalty systems. The offers are gamified within the mobile application by the service, and one is selected by the consumer. Once selected, the consumer is unable to access any other offers for the goods and services via the app until the consumer redeems the selected offer or until a given amount of elapsed time has passed. Redemption is tracked and the consumer is rewarded with game-based artifacts/points and the searching feature of the app reactivated before the elapsed time passes.

### BACKGROUND

Digital advertising has successfully used online data to match consumer tastes to specific brands and selectively advertise to that audience segment.

However, ad content remains irritating to consumers and ad campaigns experience dramatically low conversion rates (few consumers actually redeem the campaigns’ offers). Moreover, consumers struggle with maintaining and accessing electronic coupons so much so that consumers have become averse to electronic offers because the vast majority of the offers were not asked for, are untimely, are too specific, and were not wanted by the consumers.

Each electronic offer comes with its own set of expiration dates and conversion requirements. Consequently, even offers desired by consumers are often held too long and have long since expired before the consumers attempt to redeem them.

Most electronic offers are provided by retailers through social media platforms; retailers are now discovering that social media redemption rates are significantly smaller than originally expected and their customers view the social media ads as a necessary annoyance to participation on social media platforms. From the perspective of the retailers, when targeted ads fail, they feel as if they are paying to frustrate their own customers.

Furthermore, the delivery mechanism relied upon by retailers to provide offers fails to account and to capture impulse buyers. An impulse buyer is ready to purchase and yet the industry has failed to adequately identify and target these potential customers. As a result, a substantial and a lucrative consumer segment is completely missed by the retailers with their existing campaigns.

In summary, repetitive ads delivered to consumers, overly specific ads, and ads for items that the consumers have already purchased frustrate and disenfranchise potential customers of the retailers.

### SUMMARY

In various embodiments, a system and methods for a targeted gamified ecommerce service are presented.

According to an embodiment, a method for operating a targeted gamified ecommerce service is provided. A user is registered for a gamification system via a mobile application (app). Search terms for an item are received from the user through the app. Transaction systems of retailers are searched for the search terms. Results returned from the searching are filtered into a predefined number of retailers. Game identifiers with the predefined number of results are associated to select game elements of a game. The app is instructed to initiate the game on a user-operated device that processes the app. A particular game identifier determined during game play of the game is identified based on a particular select game element of the game. The particular game identifier is mapped to a particular result associated with a particular retailer. The particular retailer associated with the particular game identifier, an item identifier for the item, and an offer associated with purchasing the item from the particular retailer is provided to the app.

### BRIEF DESCRIPTION OF THE DRAWINGS

FIG. 1 is a diagram of a system for providing and operating a targeted gamified ecommerce service, according to an example embodiment.

FIG. 2 is a diagram of a method for providing a targeted gamified ecommerce service, according to an example embodiment.

FIG. 3 is a diagram of another method for operating a targeted gamified ecommerce service, according to an example embodiment.

### DETAILED DESCRIPTION

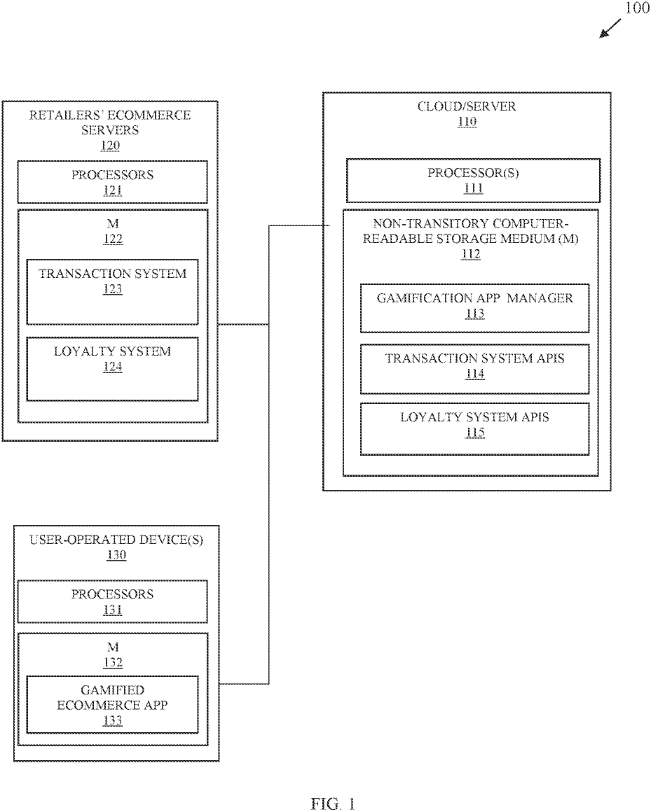

FIG. 1 is a diagram of a system/platform 100 for providing and operating a targeted gamified ecommerce service, according to an example embodiment, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of providing and operating a targeted gamified ecommerce service, presented herein and below.

System/platform 100 (herein after just “system 100”) provides a processing environment by which a targeted and gamified ecommerce service is provided with a mobile application (app) operated by consumers. When a consumer is ready to make a purchase of a good/service, the consumer searches for the good/service via a user-facing interface of the app and the services uses Application Programming Interfaces (APIs) to identify a select group of retailers along with offers and pricing provided by those retailers for the good/service. The select group and their offers are gamified within the user-facing interface for selection by the consumer during game play of a game. Once the consumer makes a selection or completes the game with a selection, the consumer is unable to search for any additional goods/services until the service identifies that the selected offer was redeemed by the consumer or until a set amount of elapsed time passes. When a redemption is identified, the consumer is rewarded with game-based artifacts, prestige within a community of consumers having the app, and/or loyalty points or gifts offered by a retailer. As the consumer earns prestige, the consumer’s level of play increases additional artifacts, prestige, and/or retailer-based loyalty points or gifts.

A variety of embodiments and operational features of system 100 is now discussed with reference to FIG. 1.

As used herein, the terms “user,” “consumer,” and/or “customer,” may be used interchangeably and synonymously herein and below. This refers to an individual who is operating a user-operated device and engaging in games that reward the individual by redeeming retailer-provided offers for goods/services during game play.

“Gamification” and or “gamified” refers to integrating or adding elements of a game during game play based on point scoring, game community prestige, game artifacts, game levels, and/or competition with others within the community in accordance with game rules. A given game completes or reaches a given game milestone upon tracking of a real-world redemption by a user of a given retailer-provided offer for a given good/service. User activities associated with obtaining offers and redeeming the offers are integrated as elements of a given game in accordance with game rules.

The system 100 comprises a cloud/server 110, a plurality of retailers’ ecommerce servers 120, and a plurality of user-operated devices 130.

Cloud/server 110 comprises at least one processor 111 and a non-transitory computer-readable storage medium 112. Medium 112 comprises executable instructions for a gamification application (app) manager 113 (hereinafter just “app manager 113”), transaction system Application Programming Interfaces (APIs) 114, and loyalty system APIs 115. The executable instructions when provided to processor 111 from medium 112 cause the processor 111 to perform operations discussed herein and below with respect to 113-115.

Each retailer ecommerce server 120 comprises at least one processor 121 and a non-transitory computer-readable storage medium 122. Medium 122 comprises executable instructions for transaction system 123 and loyalty system 124. The executable instructions when provided to processor 121 from medium 122 cause the processor 121 to perform operations discussed herein and below with respect to 123-124.

Each user-operated device 130 comprises at least one processor 131 and a non-transitory computer-readable storage medium 132. Medium 132 comprises executable instructions for a gamified ecommerce app 133 (hereinafter just “app 133”). The executable instructions when provided to processor 131 from medium 132 cause the processor 131 to perform operations discussed herein and below with respect to 133.

Initially, a user/consumer/customer registers with cloud/server for targeted gamified offers and downloads app 133 to their device 130. When the user initiates app 133 on device 130, the user is presented with a search screen within the user-facing interface of app 133. The user is instructed within the search screen to perform a search for a good/service that the user is currently interested in buying.

The user provides search terms such as brand (if desired), type of item/good/service, etc. App 133 provides the user-identifier registered for the user with cloud/server 110, device identifier for device 130, a current physical location of device 130 (optional), and the user-provided search terms to app manager 113. App manager 113 obtains a profile of the user that comprises preferences for items, brands, and game play options. The profile provided during user registration and developed as the user interacts with app manager 113.

App manager 113 may modify the search terms based on the user preferences in the user profile and uses APIs 114 and 115 to perform a search of multiple retailers transaction systems 123 for the item/good that matches the search terms in the transaction systems 123 and locates offers associated with the item/good in the loyalty systems 124.

The search results returned from the search by app manager 113 comprises retail identifiers for retailers, item identifiers for the items, and offer identifiers and conditions for the corresponding offers. The search results comprises sets of retailer identifiers, item identifiers, and offer identifiers/conditions. Each set associated with a particular unique retailer.

App manager 113 winnows down the sets into a predefined number of selectable sets for the user during game play. The sets are reduced to the selectable sets based on a variety of factors, such as user preferences from the registered user profile, retailer identifiers, item price, offer conditions, retailers’ store locations relative to a current location of the user’s device 130, and other factors.

Once app manager 113 has reduced the search sets down to the predefined number of sets, app manager selects a game for play for the user based on game options associated with the user in the registered user profile. The sets are also sorted prior to game initiation based on the retailer, the price of the item, the value of the item after applying the corresponding offer, and/or location of a retailer’s store for the item relative to a current location of the user’s device 130.

With the predefined number of sets known, the sets sorted, and the game selected for game play, app manager 113 initiates the game with game elements in the game mapping to identifiers for each of the sets on app 133 for user game play.

The game can be a video game of chance that requires no skill by the user similar to Loot Crate® where each set is identified in a crate or a box within an animated video scene and the user selects through a user avatar or through touch a particular one of the crates. Once a crate is selected within the game play, app 113 returns the corresponding selected identifiers to app manager 113, which maps that identifiers of the selected box to a specific one of the retailers, the item, and offer. The game play reveals to the user the retailer, the item, and the offer when the user unwraps the box during game play. The offer is stored in a user-maintained wallet for app 133 as a code, such as a Quick Response (QR) code along with descriptive details, such as item X and retail store Y for a discount of Z along with an expiration date of D.

Once the item, retail store, and offer is revealed to the user during game play, a time is started for the user that is maintained by app manager 113. The user is not permitted to play any additional games, search for additional items/goods/services until either the user redeems the offer at the retail store or until a set predefined period of elapsed time passes (such as 3 days, 1 week, etc.). The purposes of this is to ensure that the user is actually converting the offers rewarded to the user during the game play of a game and to ensure that the user is visiting the retail store associated with the item and the offer.

Retailers struggle with all the on-line shopping to get consumers into their stores and system 100 provides a gamified technique for bringing customers into the stores. The potential customers (users) are rewarded with offers on items not available anywhere else but are also discouraged from game play and corresponding game status and game levels reached when provided offers are not redeemed in the stores.

The offer code is encoded with the user’s game identifier and/or device identifier for device 130, such that when the user submits the code for redemption at the store an automatic notification is sent from the corresponding transaction system 123 associated with the retail store back to app manager 113 through a corresponding transaction API 114. App manager 113 immediately unlocks app 133 of the corresponding user for additional item searching and game play and credits the user’s game account with game points or game artifacts that correspond to prestige within the gaming community of users.

App manager 113 may maintain game status, game artifacts, and points for each user and provide access to see user standings through a settings option screen within app 133. In this way, each user of the community can see their standing within the community relative to the other users.

App manager 113 may further maintain a milestone reward level, such that when a given user’s account reaches predefined point totals, levels or a top N standing within a set period of elapsed time, prizes are rewarded to the user. The milestones may be predefined along with the reward prizes. Some prizes may be gift certificates that are redeemable with a given retailer in a store of the retailer, a set amount of loyalty points awarded with a given retailer through that retailers loyalty system 124 and a user’s account with that loyalty system 124, and/or redemption certificates for a free retailer gift at a given retailer’s store.

During initial play of a first game by a given user, app 133 explains to the user the primary game rules which are using the app 133 and playing games when the user is ready to make an impulse purchase and explains to the user that any item and offer awarded to the user should be redeemed at the corresponding store in order for the user to continue playing the games and if not the user will be penalized by being locked out of the item searching and game play features until a predefined amount of elapsed time has passed since the user was awarded and offer. The initial rules are also explained that points, artifacts, status, and levels are awarded when the user actually redeems an awarded offer at the corresponding store.

When the offer code is redeemed at a store, the corresponding transaction system 123 uses API 114 to provide the game user identifier for the redeeming user back to app manager 113. App manager 113 awards points to the user’s gaming account for the redemption and notifies app 133 to reactivate item searching within app 133 for the user. A predefined scale of point totals map to predefined milestones that elevate the user’s game level and elevate the user’s standing within the gaming community. As stated before, milestones may map to additional community points and/or game artifacts.

System 100 motivates users/consumers/customers to perform impulse buying through app 133 by gamifying the buying with incentives and rewards when items desired are identified through app 133 and offers provided are redeemed by the user at a corresponding retail store associated with the offers.

In an embodiment, a variety of games can be played or selected by the user to determine a value of an offer for an item that the user is interested in buying at a brick-and-mortar store. The games can be games of chance as discussed above or can be a game of skill. The game can be a skill-based video game played by the user within the user-facing interface of app 133, wherein a score of the user at the conclusion of the game play maps to one of the sets (a particular retailer, a particular item/good, and a particular offer). A higher score renders a higher offer or lower priced item/good for the user.

In an embodiment, each type of game (skill or chance) is defined by predefined elements and game rules that are processed by app 133 in coordination with app manager 113. Special predefined elements or scores at the conclusion of a given game map to a specific set of information comprising a retailer store identifier, an item identifiers, and an offer discount.

In an embodiment, points accumulated during game plays within the game can be converted into additional offers or rewards. For example, suppose a user elected to play a game of skill and received a lower score than anticipated, app manager 113 may allow the user to convert N points accumulated in the user’s game account to the best available offer for the item desired by the user. As another example, N points can be converted into a best-available offer for a given item at a retailer, into a gift certificate for use with a specific retailer, or a redemption certificate for a free gift with a specific retailer.

In an embodiment, artifacts may be rewarded based on the level of standing of a user within the gaming community. The artifacts may include game badges, game medals, specific avatars for the user during game play, etc.

In an embodiment, points and artifacts may be awarded together when a specific game level is reached. For example, when a user reaches a gold level (milestone) within the gaming community, additional points and artifacts can be awarded to the user’s gaming account.

In an embodiment, games may be played in connection with competitions within the gaming community. Users are awarded points when offers are redeemed at the stores and a leader board is maintained for a set period of time (such as a week). At the end of the period of time (end of the week), the top N number of users are awarded points and/or artifacts based on their placement on the leader board. A winning user (top on the leader board) may be awarded a gift certificate to a given retailer for redemption.

In an embodiment, the offer code may be redeemed with an online store of the retailer by the user entering a text code associated with the offer QR code during an online checkout with the retailer’s transaction system 123.

In an embodiment, the user-operated device is a phone, a wearable processing device (watch, pendant/necklace, glasses), a tablet, a laptop, or a desktop.

In an embodiment, app 133 permits an offer to be sent from a user’s gaming wallet as a text message to a user-designated device. This may be helpful when a user plays the game on one device (tablet) but wants to redeem the offer awarded on a different device (phone). This may also be useful to allow a user to transfer an award from the user to the user’s spouse or children.

In an embodiment, retailers bid for game space and presence within app 133 for selection by app manager 113. Some retailers may bid for providing a rare or exclusive customer offer, which may be gamified within the game as visually more appealing with enhanced animation for user attention and selection during game play.

In an embodiment, app 133 is a mobile application downloaded from an app store on a mobile device 130.

In an embodiment, app 133 is browser-based interface accessible from device 130 through a browser application processing on device 130.

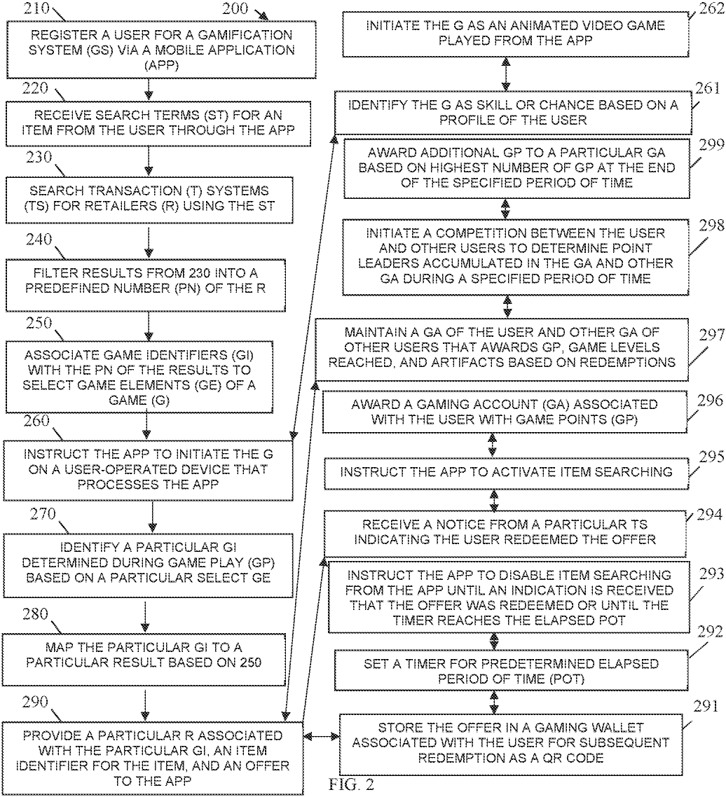

The above-referenced embodiments and other embodiments are now discussed within FIGS. 2—3.

FIG. 2 is a diagram of a method 200 for providing a targeted gamified ecommerce service, according to an example embodiment. The software module(s) that implements the method 200 is referred to as a “gamified app manager.” The gamified app manager is implemented as executable instructions programmed and residing within memory and/or a non-transitory computer-readable (processor-readable) storage medium and executed by one or more processors of one or more devices. The processor(s) of the device that executes the gamified app manager are specifically configured and programmed to process the gamified app manager. The gamified app manager may have access to one or more network connections during its processing. The network connections can be wired, wireless, or a combination of wired and wireless.

In an embodiment, the device that executes the gamified app manager is server 110. In an embodiment, server 110 is one of several servers logically cooperating as a single server within a cloud 110.

In an embodiment, the gamified app manager is all or some combination of 113, 114, 115, and/or 133.

At 210, the gamified app manager registers a user for a gamification system 100 via a mobile application (app) 133.

At 220, the gamified app manager receives search terms for an item from the user through the app 133. The user is indicating and is aware of the fact that by searching for the item from app 133, the user is indicating that the user is ready to buy the item searched for.

At 230, the gamified app manager searches transaction systems 123 for retailers using the search terms.

At 240, the gamified app manager filters results from 230 into a predefined number of the retailers.

At 250, the gamified app manager associates game identifiers with the predefined number of the results to select game elements of a game.

At 260, the gamified app manager instructs the app 133 to initiate the game on a user-operated device 130, which processes the app 133.

In an embodiment, at 261, the gamified app manager identifies the game as a game of skill, or a game of chance based on a profile of the user.

In an embodiment of 261 and at 262, the gamified app manager initiates the game as an animated video game played from the app 133.

At 270, the gamified app manager identifies a particular game identifier that was determined during game play based on a particular selected game element during game play.

At 280, the gamified app manager maps the particular game identifier to a particular result based on 250.

At 290, the gamified app manager provides a particular retailer associated with the particular game identifier, an item identifier for the item, and an offer to the app 133 for presentation to the user during game play of the game.

In an embodiment, at 291, the gamified app manager stores the offer in a gaming digital wallet associated with the user for subsequent redemption as a QR code.

In an embodiment of 291 and at 292, the gamified app manager sets a timer for a predetermined elapsed period of time.

In an embodiment of 292 and at 293, the gamified app manager instructs the app 133 to disable item searching from the app 133 until an indication is received that the offer was redeemed or until the time reaches or passes the elapsed period of time of the timer.

In an embodiment, at 294, the gamified app manager receives a notice from a particular transaction system 123 indicating the user redeemed the offer.

In an embodiment of 294 and at 295, the gamified app manager instructs the app 133 to activate item searching within the user-facing interface of app 133.

In an embodiment of 295 and at 296, the gamified app manager awards a gaming account associated with the user with game points based on the notice of redemption at 294.

In an embodiment, at 297, the gamified app manager maintains a gaming account for the user and other gaming accounts of other users that awards game points, game levels reached, and game artifacts based on redemptions of offers for items purchased.

In an embodiment of 297 and at 298, the gamified app manager initiates a competition between the user and the other users to determine point leaders accumulated in the gaming account and the other gaming accounts during a specified period of time.

In an embodiment of 298 and at 299, the gamified app manager awards additional game points to a particular gaming account based on highest number of game points at the end of the specified period of time for the competition.

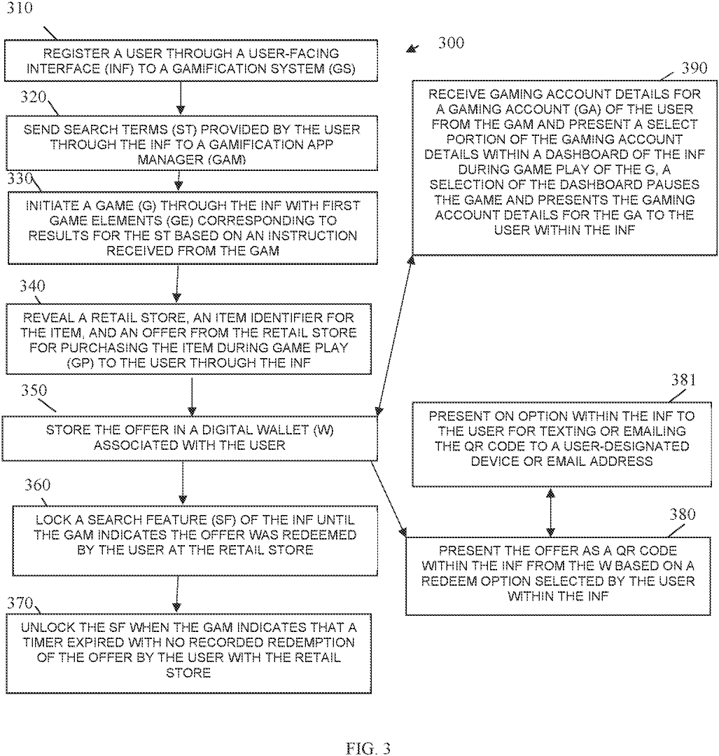

FIG. 3 is a diagram of another method 300 for operating a targeted gamified ecommerce service, according to an example embodiment. The software module(s) that implements the method 300 is referred to as a “gamified ecommerce app.” The gamified ecommerce app is implemented as executable instructions programmed and residing within memory and/or a non-transitory computer-readable (processor-readable) storage medium and executed by one or more processors of a device. The processors that execute the gamified ecommerce app are specifically configured and programmed for processing the gamified ecommerce app. The gamified ecommerce app may have access to one or more network connections during its processing. The network connections can be wired, wireless, or a combination of wired and wireless.

In an embodiment, the device that executes the gamified ecommerce app is device 120. In an embodiment, the device 120 is a phone, a tablet, a laptop, a desktop, or a wearable processing device (phone, watch, glasses, etc.).

In an embodiment, the gamified ecommerce app is 133.

The gamified ecommerce app interacts with app manager 113 and/or method 200 of FIG. 2.

At 310, the gamified ecommerce app registers a user through a user-facing interface to a gamification system 100.

At 320, the gamified ecommerce app sends search terms provided by the user through the user-facing interface to a gamification app manager 113.

At 330, the gamified ecommerce app initiates a game through the user-facing interface with first game elements corresponding to results for the search terms based on an instruction received from the gamification app manager 113.

At 340, the gamified ecommerce app reveals a retail store, an item identifier for the item, and an offer from the retail store for purchasing the item during game play to the user through the user-facing interface.

At 350, the gamified ecommerce app stores the offer in a digital wallet associated with the user.

In an embodiment, at 360, the gamified ecommerce app locks a search feature of the user-facing interface until the gamification app manager 113 indicates the offer was redeemed by the user at the retail store.

In an embodiment of 360 and at 370, the gamified ecommerce app unlocks the search feature when the gamification app manager 113 indicates a timer expired with no recorded redemption of the offer by the user with the retail store.

In an embodiment, at 380, the gamified ecommerce app presents the offer as a QR code within the user-facing interface from the digital wallet based on a redemption option selected by the user within the user-facing interface.

In an embodiment of 380 and at 381, the gamified ecommerce app presents an option within the user-facing interface to the user for texting or emailing the QR code to a user-designated device or a user-designated email address.

In an embodiment, at 390, the gamified ecommerce app receives gaming account details for a gaming account of the user from the gamification app manager 113. The gamified ecommerce app presents a select portion of the gaming account details within a dashboard of the user-facing interface during game play of the game. The gamified ecommerce app pauses the game and presented the gaming account details within the user-facing interface when the user selects the dashboard during game play of the game.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
registering a user for a gamification system via a mobile application (app);
receiving search terms for an item from the user through the app;
searching transaction systems of retailers using the search terms;
filtering results from the searching into a predefined number of the retailers;
associating game identifiers with the predefined number of the results to select game elements of a game
instructing the app to initiate the game on a user-operated device that processes the app;
identifying a particular game identifier determined during game play of the game based on a particular select game element;
mapping the particular game identifier to a particular result based on the associating; and
providing a particular retailer associated with the particular game identifier, an item identifier for the item, and an offer associated with purchasing the item from the particular retailer to the app.

2. The method of claim 1 further comprising, storing the offer in a gaming wallet associated with the user for subsequent redemption as a Quick Response (QR) code.

3. The method of claim 2 further comprising, setting a timer for a predetermined elapsed period of time.

4. The method of claim 3 further comprising, instructing the app to disable item searching from the app until an indication is received that the offer was redeemed or until the time reaches the predetermined elapsed period of time.

5. The method of claim 1 further comprising, receiving a notice from a particular transaction system indicating that the user redeemed the offer for the item with the particular retailer.

6. The method of claim 5 further comprising, instructing the app to activate item searching from the app.

7. The method of claim 6 further comprising, awarding a gaming account associated with the user with a predefined number of game points based on the notice of item redemption.

8. The method of claim 1 further comprising, maintaining a gaming account for the user and other gaming accounts for other users that awards game points, game levels reached, and game artifacts based on redemptions of game-provided offers.

9. The method of claim 8 further comprising, initiating a competition between the user and the other users to determine and to reward point leaders within a gaming community for the corresponding game points accumulated in the gaming account and other gaming accounts during a specified period of time.

10. The method of claim 9, further comprising, awarding additional game points to a particular gaming account based on highest number of game points at the end of the specified period time.

11. The method of claim 1, wherein instructing further includes identifying the game from a profile setting of the user as a game of chance or a game of skill.

12. The method of claim 11, wherein identifying the game further includes initiating the game as an animated video game played from the app.

13. A method, comprising:
registering a user through a user-facing interface to a gamification system;
sending search terms for an item provided by the user through the user-facing interface to a gamification application (app) manager;
initiating a game through the user-facing interface with first game elements corresponding to results for the search terms based on an instruction received from the gamification app manager;
revealing a retail store, an item identifier for the item, and an offer from the retail store for purchasing the item during game play of the game to the user through the user-facing interface; and
storing the offer in a digital wallet associated with the user.

14. The method of claim 13 further comprising, locking a search feature of the user-facing interface until the gamification app manager indicates the offer was redeemed by the user at the retail store.

15. The method of claim 14 further comprising, unlocking the search feature when the gamification app manager indicates that a timer expired with no recorded redemption of the offer by the user with the retail store.

16. The method of claim 13 further comprising, presenting the offer as a Quick Response (QR) code within the user-facing interface from the digital wallet based on redeem option selected by the user within the user-facing interface.

17. The method of claim 16 further comprising, presenting an option within the user-facing interface to the user for texting or emailing the QR code to a user-designated device or email address.

18. The method of claim 13 further comprising, receiving gaming account details for a gaming account of the user from the gamification app manager and presenting a select portion of the gaming account details within a dashboard of the user-facing interface during game play of the game, a selection of the dashboard pauses the game and presents the gaming account details for the gaming account to the user within the user-facing interface.

19. A system, comprising:
at least one server comprising a processor and a non-transitory computer-readable storage medium;
the non-transitory computer-readable storage medium comprises executable instructions; and
the executable instructions when executed on the processor from the non-transitory computer-readable storage medium cause the processor to perform operations comprising:
registering a user to a gaming account associated with games where points, levels, and artifacts are awarded to the user based on redemption of offers to purchase items at retail stores, wherein the offers are mapped to gaming elements during game play of the games;
processing a search for an item received through a mobile application operating a user device and obtaining a set of offers for the item, each offer associated with a particular retail store;
mapping each offer of the set to a particular gaming element of a game;
instructing the mobile application to initiate the game for the user on the user device;
identifying a game-determined offer during game play of the game from the mobile application;
revealing a game-determined retail store, an item identifier for the item, and the game-determined offer to the user through the mobile application;
instructing the mobile application to disable an item searching feature within the mobile application preventing the user from searching for other items;
setting a timer for a predetermined period of elapsed time; and
instructing the mobile application to enable the item searching when a redemption of the game-determined offer was redeemed by the user at the game-determined retail store or when the time passes the predetermined period of elapsed time; and
adding additional points to the gaming account when the game-determined offer was redeemed by the user at the game-determined retail store.

20. The system of claim 19, wherein the executable instructions further instructions that cause the processor to perform additional operations comprising:
maintaining other gaming accounts for other users;
initiating a competition between the user and the other users;
maintaining a leader board based on the competition using point totals accumulated in the gaming account and the other gaming accounts during the competition;
providing a leader board during the competition for viewing by the user and the other users based on current point totals in the gaming account and the other gaming accounts;
awarding further points to a predefined number of the gaming account and the other gaming accounts based on a final state of the leader board when the competition ends.
